(19) United States
(12) Patent Application Publication
(10) Pub. No.: US 2024/0113769 A1
(43) Pub. Date: Apr. 4, 2024

(54) NETWORK EXPANSION TO REMOTE SITES UTILIZING SECURE AUTONOMOUS OR REMOTELY PILOTED VEHICLE AS A REMOTE MULTI-ACCESS EDGE COMPUTER

(71) Applicant: INTERNATIONAL BUSINESS MACHINES CORPORATION, ARMONK, NY (US)

(72) Inventors: Mathews Thomas, Flower Mound, TX (US); Sharath Prasad Krishna Prasad, Flower Mound, TX (US); Sai Srinivas Gorti, Irving, TX (US); Amandeep Singh, Carrollton, TX (US); Dushyant K. Behl, Bangalore (IN); Utpal Mangla, Toronto (CA)

(21) Appl. No.: 17/937,879

(22) Filed: Oct. 4, 2022

(51) Int. Cl. H04B 7/155; H04L 67/00; H04W 12/06; H04W 28/08

(52) U.S. Cl. CPC H04B 7/15507; H04L 67/34; H04W 12/06; H04W 28/0925; H04W 88/04

(57) ABSTRACT

A communication system for a remote location, which is out of range of a telecom provider, is provided. The communication system includes a remote multi-access edge computer (RMEC) proximate to the remote location and communicative with the telecom provider. The RMEC is configured to run software of the telecom provider whereby the RMEC is securely connectable with the telecom provider such that the RMEC is capable of providing cellular connectivity to a cell phone operably deployed at the remote location.

### BACKGROUND

The present invention generally relates to communication systems and, more specifically, to network expansion to remote sites for communication systems utilizing secure autonomous or remotely piloted vehicle as a remote multi-access edge computer (RMEC).

Advanced telecommunications networks, including 5G networks, offer certain features that are far more sophisticated and flexible than predecessor technologies. For example, while 4G networks offer trilateration capabilities that allow a carrier to locate a user's position within about a hundred feet by comparing signals from multiple cell towers, 5G and later networks can trilaterate a device's location with at least one order-of-magnitude greater precision, allowing a user's position to be identified within a range of tens of feet.

5G and similar networks can also handle far more simultaneous connections, making them more practical for Internet of Things applications, which can associate numerous IoT sensor devices with a single user. Such networks can also open high-bandwidth ad hoc channels that exhibit very low latency, allowing large groups of users to connect and disconnect at will in a dynamic mesh network. In addition, these networks can integrate artificially intelligent or cognitive applications directly into their network infrastructure, rather than requiring such functionality to be implemented as extrinsic services hosted by a cloud-computing service or other third-party resource.

5G networks enable the mass deployment of IoT devices by providing the ability to dynamically manage very large numbers of devices on ad hoc mesh networks. If, for example, a thousand people watching a parade are each carrying an average of five IoT devices, a legacy Internet Service Provider (ISP) would likely be unable to simultaneously manage and correlate the resulting large number of connections. The flexible service-orchestration capabilities of a 5G network, on the other hand, after detecting the presence of a mass assembly, allow the network to dynamically create an ad hoc mesh network that continuously adds and removes users as IoT devices log in and log out. Unlike legacy networks, which would require an extrinsic application, such as a hosted cloud service, to even approximate such features, 5G platforms support such high-speed ad hoc infrastructure through integrated, native orchestration services.

### SUMMARY

Embodiments of the present invention are directed to a communication system for a remote location, which is out of range of a telecom provider. A non-limiting example of the communication system includes a remote multi-access edge computer (RMEC) proximate to the remote location and communicative with the telecom provider. The RMEC is configured to run software of the telecom provider whereby the RMEC is securely connectable with the telecom provider such that the RMEC is capable of providing cellular connectivity to a cell phone operably deployed at the remote location.

Embodiments of the present invention are directed to a communication system. A non-limiting example of the communication system includes a telecom provider, a remote location on a body of water or at a remote land area, which is out of range of the telecom provider, a satellite and a remote multi-access edge computer (RMEC) comprising an autonomous or remotely piloted vehicle. The RMEC is proximate to the remote location and communicative with the telecom provider via the satellite and configured to run software of the telecom provider whereby the RMEC is securely connectable with the telecom provider such that the RMEC is capable of providing cellular connectivity to a cell phone operably deployed at the remote location.

Embodiments of the invention are directed to a method of operating a communication system for a remote location, which is out of range of a telecom provider.

A non-limiting example of the method includes initializing, at a remote multi-access edge computer (RMEC), a trusted execution environment (TEE) that establishes communications with the telecom provider. The method further includes receiving, via the TEE, software of the telecom provider and running the software of the telecom provider within the TEE to securely connect the RMEC to the telecom provider such that the RMEC is capable of providing cellular connectivity to a cell phone operably deployed at the remote location.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a communication system in accordance with one or more embodiments of the present invention;

FIG. 2 is a flow diagram illustrating a method of operating a communication system in accordance with one or more embodiments of the present invention;

FIG. 3 graphically depicts an operation of the method of FIG. 2 in accordance with one or more embodiments of the present invention; and

FIG. 4 is a schematic illustration of a computing environment that can execute the method of FIG. 2 in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, advancements in radio technologies have led to the use of higher frequency bands to support ultra-low latency communications. But with these changes, coverage area per base station is reducing and the cost of deploying new base stations is increasing substantially. Moreover, decisions about placement of the next generation (5G and 6G) base stations and network edge nodes are influenced by the density of users present at a particular location. These factors, taken together, will tend to leave big gaps in coverage.

In an exemplary case, a user works at an oil mining station in the middle of an ocean. Since the oil mining station is in a very remote location, no cell towers or antennas are present nearby. Hence people at the oil mining station need to use specialized hardware like satellite phones for connectivity. Such specialized hardware is limited and cannot be provided to everyone. In another exemplary case, another user works for a heavy metal refinery in the middle of a desert and has the same issue with connectivity as the first user and the same need for specialized hardware.

Communication service providers are in the process of building out a 5G network across the world. However, because high frequency waves have a harder time traveling over distance and through objects, the 5G network will generally need to be built on small cell site technology with antennas as close as 500 feet apart. This will require a lot of cell towers to be built by the communication service providers.

While attempts to address the problem of gaps in coverage without building out large numbers of cell towers at substantial expense have been proposed, issues remain. For example, some attempts have focused on using autonomous or remotely piloted vehicle base stations and base station management methods and apparatuses for providing cell coverage from the air and other attempts involve base station communication modules being loaded on autonomous or remotely piloted vehicles to temporarily provide communication services. Still other attempts relate to self-organizing networks that are able to identify congestion points in radio coverage at a geographic location and to deploy autonomous or remotely piloted vehicles accordingly. In each case, the proposals lack the ability to load and offload network functions.

Turning now to an overview of the aspects of the invention, one or more embodiments of the invention address the above-described shortcomings of the prior art by enabling telecommunication providers (hereinafter referred to as “telecom providers”) to allow anyone to use hardware, such as autonomous or remotely piloted vehicles with compute capability, to be deployed as multi-access edge devices and to additionally enable the telecom providers to securely offload network functions that allow the autonomous or remotely piloted vehicles to effectively form networks in remote locations.

The above-described aspects of the invention address the shortcomings of the prior art by allowing telecom providers to securely offload network functions to a third-party compute site, such as a remote multi-access edge computer (RMEC). The RMEC can be an autonomous or remotely piloted vehicle not belonging to the telecom provider and can download the necessary virtual network functions required to set up a network for an enterprise requesting it. As such, the RMEC alone or in combination with other RMECs can form a 5G/6G network in remote locations where no existing infrastructure and network service is available. The network functions can be selected based on various factors including, but not limited to, user requirements, traffic patterns and RMEC resource capabilities that can be ascertained by dynamic analysis. In cases in which the RMEC is movable, as in autonomous or remotely piloted vehicles, the RMECs can also temporarily store data and if needed travel to better locations for data transfers. In certain cases when connectivity cannot be established, the RMEC(s) can provide for local connectivity at remote locations and form a private network of 5G edge sites.

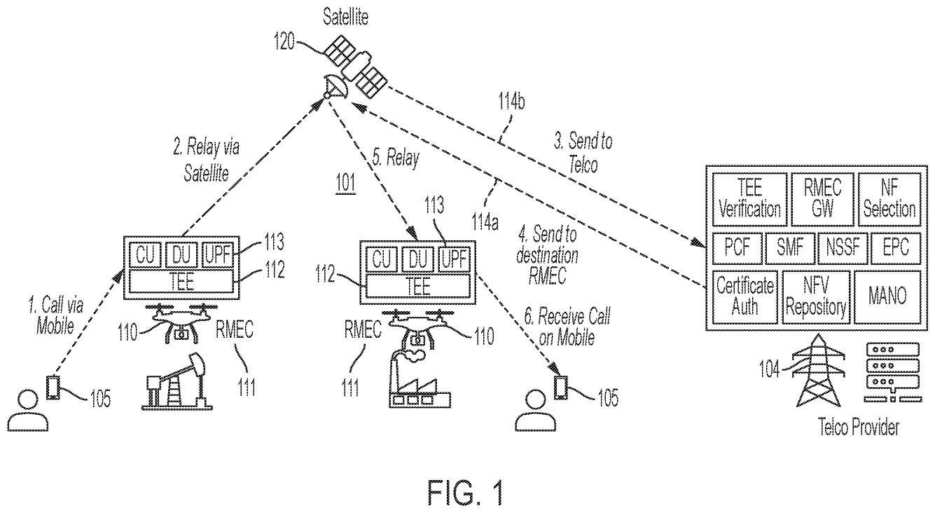

Turning now to a more detailed description of aspects of the present invention, FIG. 1 depicts a communication system 101 for a remote location, such as an oil rig 102 in a middle of a body of water (i.e., an ocean) or a mining facility 103 in a land area (i.e., a middle of a desert), which is out of range of a telecom provider 104, according to embodiments of the invention. The communication system 101 includes an RMEC 110 and, in some cases, a satellite 120. The RMEC 110 can include or be provided as an autonomous or remotely piloted vehicle 111 and is disposed or deployed in a location proximate to the remote location. The RMEC 110 is communicative with the telecom provider 104 via the satellite 120. The RMEC 110 is also directly communicative with a cell phone 105 of a user which is operably deployed at the remote location. The RMEC 110 is configured to run software of the telecom provider 104 whereby the RMEC 110 is securely connectable with the telecom provider 104. By running the software of the telecom provider 104, the RMEC 110 becomes capable of providing cellular connectivity to the cell phone 105.

In accordance with one or more embodiments of the present invention, the RMEC 110 can include a radio system that can provide services akin to a radio access network (RAN). The RMEC 110 can also include processors configured to support this such radio communications (e.g., Cortex A53). In some cases, the RMEC 110 can also employ a satellite communication backend in addition to providing cellular connections as described herein.

In accordance with one or more embodiments of the present invention, the satellite 120 can include or be provided as an artificial communications satellite that is disposed and configured to relay and amplify radio telecommunication signals or other types of signals via a transponder. In any case, the satellite 120 creates a communication channel between a source transmitter and a receiver at different locations (i.e., at the remote location and at the telecom provider 104).

The software of the telecom provider 104 includes network functions. These network functions can include, but are not limited to, at least one or more of policy and charging functions, session and access management functions, network slice selection functions, evolved packet core functions, certificate authentication functions and management and orchestration functions. Policy and charging functions are engine managing policies based on user and application vendor agreements. Session and access management functions are responsible for creating and managing user session contexts. Network slice selection functions identify suitable network slices as per an assessed requirement. Evolved packet core functions provide handover and backward compatibility between 5G and LTE networks. Certificate authentication functions provide relatively easy ways to authenticate traffic, verify trusted execution environment (TEE) quotes and establish transport layer security (TLS) channels via remote RMEC 110 sites to telecom providers 104. Management and orchestration functions provide for executions of zero touch provisions and management of network functions to the RMEC 110.

During an operation of the communication system 101, the RMEC 110 is configured to establish a TEE 112. Once that is accomplished, the network functions 113 that are to be run by the RMEC 110 are offloaded to the RMEC 110 from the telecom provider 104 by way of a TLS channel 114a, 114b with the TEE 112. A selection of which of the network functions 113 is/are to be run on the RMEC 110 can be based multiple factors including, but not limited to, at least details of agreements, execution capacity and capability of the RMEC 110, user requirements, network traffic, available resource capabilities of the RMEC 110, etc.

In accordance with one or more embodiments of the present invention, it is to be understood that the RMEC 110 can be provided as multiple RMECs 110. In these or other cases, the respective TEEs 112 of each of the multiple RMECs 110 can form a cluster/mesh and provide a collective view of the available capabilities to the telecom provider 104 with one of the multiple RMECs 110 being designated as a lead RMEC 110 and the others can be designated as delegate RMECs 110. The lead RMEC 110 is designated as the lead using a consensus algorithm or another similar designation algorithm and communicates with the telecom provider 104 for the cluster/mesh. The lead RMEC 110 also delegates tasks to the delegate RMECs 110.

Whereas there are currently connectivity gaps for people at locations like oil mining stations and remote refineries, the communication system 101 fills those connectivity gaps by securely offloading the network functions 113 from telecom providers 104 to (effectively) the companies running these remote locations.

In an exemplary case, a company running a remote location has provisions for an autonomous or remotely piloted vehicle to be used as an RMEC 110 as described above. The company then register or otherwise authorize themselves with a telecom provider 104. This allows for a TLS channel to be established between the remote location and the telecom provider 104 (i.e., using an existing satellite 120). A TEE 112 is started on the RMEC 110 and sends a remote attestation quote of the TEE 112 to the telecom provider 104. The telecom provider 104 then verifies the attestation quote and selects appropriate network functions 113 as software to offload onto the RMEC 110. The network functions 113 offloaded by the telecom provider 104 are unpacked in the TEE 112 and a quote is generated by the TEE 112. The quote is sent to the telecom provider 104, which verifies the quote and, if successful, starts a connection with the RMEC 110 that now acts like an edge computing site from the perspective of the telecom provider 104. Users at the remote location now connect to the RMEC 110 locally using their own mobile or cell phones and can call anyone anywhere without using special hardware. The TEE 112 provides complete security and confidentiality, which is verifiable by the telecom provider 104 remotely using the quote verification. The telecom provider 104 does not need to install and maintain infrastructure at the remote location.

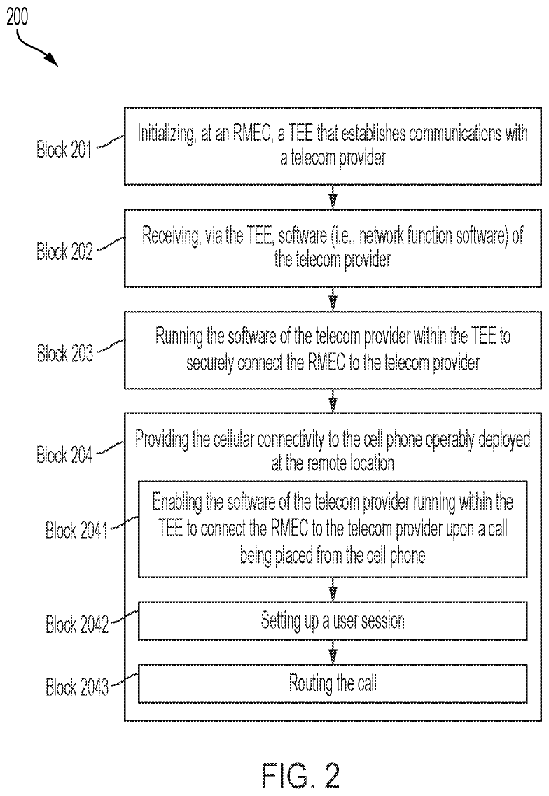

With reference to FIG. 2, a method 200 of operating a communication system (i.e., the communication system 101 of FIG. 1) for a remote location, which is out of range of a telecom provider, is provided. As shown in FIG. 2, the method includes initializing, at an RMEC, a TEE that establishes communications with the telecom provider at block 201. As further shown in FIG. 2, the method also includes receiving, via the TEE, software (i.e., network function software) of the telecom provider at block 202 and running the software of the telecom provider within the TEE to securely connect the RMEC to the telecom provider at block 203. The RMEC is thus made capable of providing cellular connectivity to a cell phone that is operably deployed at the remote location.

In accordance with one or more embodiments of the present invention, the method can further include providing the cellular connectivity to the cell phone operably deployed at the remote location at block 204. In these or other cases, the providing of the cellular connectivity includes enabling the software of the telecom provider running within the TEE to connect the RMEC to the telecom provider upon a call being placed from the cell phone at block 2041, setting up a user session for the call at block 2042 and routing the call at block 2043.

As above, the remote location is on a body of water or at a remote land area and the RMEC can include or be provided as an autonomous or remotely piloted vehicle.

The communications established by the TEE at block 201 include an attestation quote and further include hardware information of the RMEC sent from the RMEC to the telecom provider and network function software of the telecom provider sent from the telecom provider to the RMEC. The running of the software of the telecom provider within the TEE at block 203 can include receiving initialization data for the software of the telecom provider.

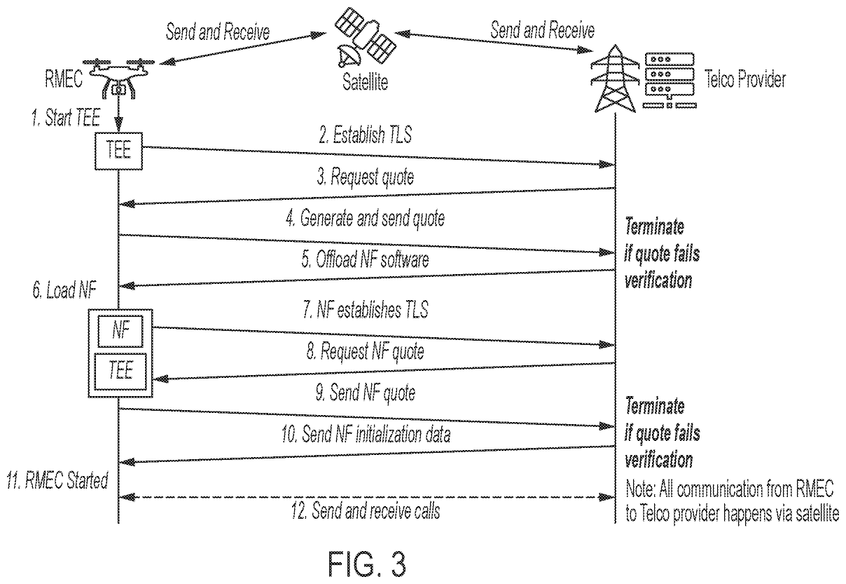

With reference to FIG. 3, the method of FIG. 2 will now be described in greater detail.

The TEE is started on the RMEC device and is initialized with connection information it needs to connect to the telecom provider. After the TEE is loaded with the connection information, the TEE establishes a connection with the telecom provider. The telecom provider then establishes a TLS channel with the TEE and offloads network function software to the RMEC. At this point, the telecom provider will have needed to determine which network function software to offload to the RMEC. This determination can be based on various factors including, but not limited to, at least details of agreements, execution capacity and capability of the RMEC 110, user requirements, network traffic, available resource capabilities of the RMEC 110, etc. For this, the telecom provider can ask the TEE for available compute and other capabilities on the RMEC. The TEE can then collect hardware info (e.g., cpu, memory, storage, antennas, etc.) and send it to an RMEC gateway (RMEC GW) running on the telecom provider. The network function software selection at minimum provides the RMEC with software which offloads vRAN-type capabilities to the RMEC and possibly other functionality like dataplane UPF based on the available resources on the RMEC. The offloaded network function software is securely loaded on the RMEC.

The TEE then provides a signed remote attestation quote to the telecom provider and the telecom provider verifies the sign and then the quote against another well-known quote. If the quote is verified, the telecom provider proceeds. If not, the telecom provider terminates the connection. A remote attestation (link) can be used to verify the integrity of network function software running on the RMEC. The TEE then generates a signed quote of the downloaded network function software and sends the signed quote back to the telecom provider. The telecom provider checks the sign and the quote and if found correct sends initialization instructions to the TEE/software and establishes a secure channel for communication. If the quote fails verification, the connection gets terminated.

The offloaded network function software establishes a secure line (e.g., TLS) with the telecom provider. Once the network function environment is setup and the TLS is verified, the telecom provider requests the TEE on the RMEC to generate and send a quote. The TEE on the RMEC generates and sends this quote to the telecom provider for verification. The telecom provider verifies the quote received from the TEE of the RMEC. If the quote is verified, the telecom provider sends the network function initialization data. If the quote verification fails, the telecom provider will terminate the connection and send an acknowledgement message to the TEE.

After the verification is successful and the RMEC receives the initialization data, the RMEC can start to provide communications service to the remote location. At this point, users at the remote location can connect to the RMEC using their mobile or cell phones. The RMEC can take connection requests from the mobile or cell phones and pass it on to the telecom provider and thus the users can start sending and receiving calls.

Once the network is setup, a call is placed from a cell phone connected to the RMEC at a remote location. Network functions running on the RMEC connect to the satellite and the satellite sends information to core functions running at a telecom provider to setup a user session context. Once the user session is setup, the core can route to the satellite. The satellite then relays the information to the destination and the RMEC is able to route calls.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as the method 200 of FIG. 2 of operating a communication system for a remote location. In addition to block 200, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and the block of the method 200, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

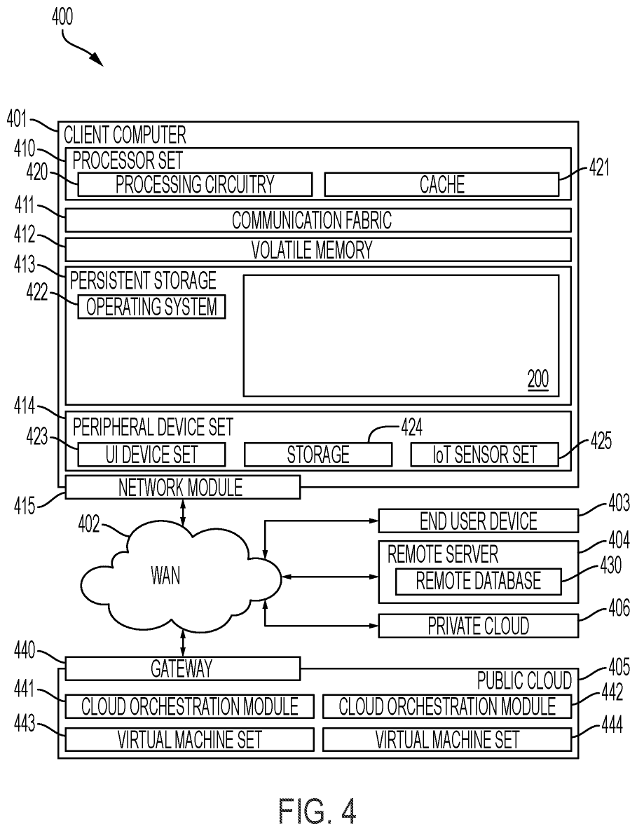

The computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

The processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in the block of the method 200 in persistent storage 413.

The communication fabric 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

The persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in the block of method 200 typically includes at least some of the computer code involved in performing the inventive methods.

The peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the Internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

The network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

The WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

The remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

The public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A communication system for a remote location, which is out of range of a telecom provider, the communication system comprising:
a remote multi-access edge computer (RMEC) proximate to the remote location and communicative with the telecom provider,
the RMEC being configured to run software of the telecom provider whereby the RMEC is securely connectable with the telecom provider such that the RMEC is capable of providing cellular connectivity to a cell phone operably deployed at the remote location.

2. The communication system according to claim 1, wherein the remote location is on a body of water or at a remote land area.

3. The communication system according to claim 1, further comprising a satellite, wherein:
the RMEC is communicative with the telecom provider via the satellite, and
the RMEC is directly communicative with the cell phone operably deployed at the remote location.

4. The communication system according to claim 1, wherein the RMEC comprises an autonomous or remotely piloted vehicle.

5. The communication system according to claim 1, wherein:
the software of the telecom provider comprises network functions, and
the network functions comprise at least one or more of policy and charging functions, session and access management functions, network slice selection functions, evolved packet core functions, certificate authentication functions and management and orchestration functions.

6. The communication system according to claim 5, wherein:
the RMEC is configured to establish a trusted execution environment (TEE), and
the network functions run by the RMEC are offloaded to the RMEC by way of a transport layer security (TLS) channel with the TEE.

7. The communication system according to claim 5, wherein a selection of which of the network functions is to be run on the RMEC is based on at least execution capacity and capability of the RMEC.

8. The communication system according to claim 1, wherein the RMEC is provided as multiple RMECs, with one designated as a lead RMEC and others designated as delegate RMECs.

9. A communication system, comprising:
a telecom provider;
a remote location on a body of water or at a remote land area, which is out of range of the telecom provider;
a satellite; and
a remote multi-access edge computer (RMEC) comprising an autonomous or remotely piloted vehicle,
the RMEC being proximate to the remote location and communicative with the telecom provider via the satellite and configured to run software of the telecom provider whereby the RMEC is securely connectable with the telecom provider such that the RMEC is capable of providing cellular connectivity to a cell phone operably deployed at the remote location.

10. The communication system according to claim 9, wherein:
the software of the telecom provider comprises network functions, and
the network functions comprise at least one or more of policy and charging functions, session and access management functions, network slice selection functions, evolved packet core functions, certificate authentication functions and management and orchestration functions.

11. The communication system according to claim 10, wherein:
the RMEC is configured to establish a trusted execution environment (TEE), and
the network functions run by the RMEC are offloaded to the RMEC by way of a transport layer security (TLS) channel with the TEE.

12. The communication system according to claim 10, wherein a selection of which of the network functions is to be run on the RMEC is based on at least execution capacity and capability of the RMEC.

13. The communication system according to claim 9, wherein the RMEC is provided as multiple RMECs, with one designated as a lead RMEC and others designated as delegate RMECs.

14. A method of operating a communication system for a remote location, which is out of range of a telecom provider, the method comprising:
initializing, at a remote multi-access edge computer (RMEC), a trusted execution environment (TEE) that establishes communications with the telecom provider;
receiving, via the TEE, software of the telecom provider; and
running the software of the telecom provider within the TEE to securely connect the RMEC to the telecom provider such that the RMEC is capable of providing cellular connectivity to a cell phone operably deployed at the remote location.

15. The method according to claim 14, wherein the remote location is on a body of water or at a remote land area.

16. The method according to claim 14, wherein the RMEC comprises an autonomous or remotely piloted vehicle.

17. The method according to claim 14, wherein the communications comprise an attestation quote.

18. The method according to claim 17, wherein the communications further comprise:
hardware information of the RMEC sent from the RMEC to the telecom provider; and
network function software of the telecom provider sent from the telecom provider to the RMEC.

19. The method according to claim 14, wherein the running of the software of the telecom provider within the TEE comprises receiving initialization data for the software of the telecom provider.

20. The method according to claim 14, further comprising providing the cellular connectivity to the cell phone operably deployed at the remote location, wherein the providing of the cellular connectivity comprises:
enabling the software of the telecom provider running within the TEE to connect the RMEC to the telecom provider upon a call being placed from the cell phone;
setting up a user session for the call; and
routing the call.
